(19) United States
(12) Patent Application Publication
(10) Pub. No.: US 2013/0046055 A1
(43) Pub. Date: Feb. 21, 2013

(54) PROCESS FOR PRODUCING AN AQUEOUS BINDER SYSTEM

(71) Applicants: Kathrin Michl, Ludwigshafen (DE); Theo Smit, Heidelberg (DE); Holger Schilling, Birkenau (DE)

(72) Inventors: Kathrin Michl, Ludwigshafen (DE); Theo Smit, Heidelberg (DE); Holger Schilling, Birkenau (DE)

(73) Assignee: BASF SE, Ludwigshafen (DE)

(21) Appl. No.: 13/586,548

(22) Filed: Aug. 15, 2012

Related U.S. Application Data
(60) Provisional application No. 61/524,807, filed on Aug. 18, 2011.

(51) Int. Cl. C08L 3/00; C09D 103/00; B29C 71/02; C09J 103/00

(52) U.S. Cl. 524/734; 264/234

(57) ABSTRACT

The invention provides aqueous binder systems comprising at least one polymeric carboxylic acid, at least one saccharide compound and at least one alkanolamine having at least two hydroxyl groups.

The present invention relates to a process for producing an aqueous binder system, which comprises, in a first process stage, free-radically polymerizing

≧50 and ≦100 parts by weight of at least one α, β-monoethylenically unsaturated mono- or dicarboxylic acid and/or anhydride thereof (monomer A1), and
≧0 and ≦50 parts by weight of at least one other ethylenically unsaturated compound copolymerizable with monomers A1 (monomer A2),
where the total amounts of monomers A1 and A2 add up to 100 parts by weight [total amount of monomers], in an aqueous medium in the presence of ≧0.1 and ≦150% by weight, based on the total amount of monomers, of at least one saccharide compound B, and then, in a second process stage, adding to the polymerization mixture obtained in the first process stage ≧0.1 and ≦70% by weight, based on the total amount of monomers, of at least one alkanolamine having at least two hydroxyl groups (alkanolamine C).

The present invention further provides the aqueous binder systems obtainable by the process according to the invention, and for the different uses thereof, a process for producing shaped articles using the aqueous binder system, and the shaped articles themselves.

The consolidation of fibrous or granular substrates, more particularly in flat structures, for example fiber webs, fiberboard or chipboard etc., is frequently accomplished by a chemical route using a polymeric binder. To increase stability, especially wet strength and thermal stability, binders comprising formaldehyde-releasing crosslinkers are frequently used. However, this gives rise to the risk of unwanted formaldehyde emission.

For avoidance of formaldehyde emissions, there have already been proposals of numerous alternatives to the binders known to date. For instance, U.S. Pat. No. 4,076,917 discloses binders which comprise polymers containing carboxylic acid or carboxylic anhydride, and β-hydroxyalkylamides as crosslinkers. A disadvantage is the relative complexity of preparation of the β-hydroxyalkylamides.

EP-A 445578 discloses panels composed of finely divided materials, for example glass fibers, in which mixtures of high molecular weight polycarboxylic acids and polyhydric alcohols, alkanolamines or polyfunctional amines function as binders.

EP-A 583086 discloses formaldehyde-free aqueous binders for production of fiber webs, especially glass fiber webs. The binders comprise a polycarboxylic acid having at least two carboxylic acid groups and in some cases also anhydride groups and a polyol. These binders require a phosphorus-containing reaction accelerator in order to achieve sufficient strengths of the glass fiber webs. It is pointed out that the presence of such a reaction accelerator can be dispensed with only when a reactive polyol is used. High-reactivity polyols specified are β-hydroxyalkylamides.

EP-A 651088 describes corresponding binders for substrates composed of cellulose fiber. These binders necessarily comprise a phosphorus-containing reaction accelerator.

EP-A 672920 describes formaldehyde-free binders, impregnating agents or coating compositions, which comprise a polymer formed to an extent of 2 to 100% by weight from an ethylenically unsaturated acid or an acid anhydride as a comonomer, and at least one polyol.

The polyols are substituted triazine, triazinetrione, benzene or cyclohexyl derivatives, the polyol radicals always being in the 1,3,5 positions of the rings mentioned. In spite of a high drying temperature, these binders on glass fiber webs achieve only low wet tear strengths.

DE-A 2214450 describes a copolymer formed from 80 to 99% by weight of ethylene and 1 to 20% by weight of maleic anhydride. The copolymer is used for surface coating together with a crosslinking agent, in powder form or in dispersion in an aqueous medium. The crosslinking agent used is a polyalcohol containing amino groups. In order to bring about crosslinking, however, heating to up to 300° C. is necessary.

U.S. Pat. No. 5,143,582 discloses the production of heat-resistant nonwoven materials using a thermally curing, heat-resistant binder. The binder is free of formaldehyde and is obtained by mixing a polymer having carboxylic acid groups, carboxylic anhydride groups or carboxylic salt groups and a crosslinker. The crosslinker is a β-hydroxyalkylamide or a polymer or copolymer thereof. The polymer crosslinkable with the β-hydroxyalkylamide is, for example, formed from unsaturated mono- or dicarboxylic acids, salts of unsaturated mono- or dicarboxylic acids or unsaturated anhydrides. Self-curing polymers are obtained by copolymerizing the β-hydroxyalkylamides with monomers comprising carboxyl groups.

U.S.-A 2004/82689 discloses formaldehyde-free aqueous binders for production of fiber webs, especially glass fiber webs, said binders consisting essentially of a polymeric polycarboxylic acid, a polyol and an imidazoline derivative. The resulting bound fiber webs are said to have reduced water absorption. There is unspecific disclosure both of nitrogen-containing and of nitrogen-free polyols, but the nitrogen-containing triethanolamine in particular is described as preferred. Specific imidazoline derivatives mentioned are reaction products of a fatty acid with aminoethylethanolamine or diethylenetriamine. The aqueous binder compositions disclosed comprise a phosphorus-containing reaction accelerator.

WO 99/09100 discloses thermally curable compositions and the use thereof as a formaldehyde-free binder for production of shaped articles, said compositions comprising, as well as an alkanolamine having at least two OH groups, a polymer 1 comprising ≦5% by weight and a further polymer 2 comprising 15% by weight of an α,β-ethylenically unsaturated mono- or dicarboxylic acid in polymerized form.

In addition, WO 10/34645 discloses aqueous binder systems for granular and/or fibrous substrates, said binder systems comprising, as active constituents, a polymer 1 comprising 5.5% by weight and 20% by weight of an α,β-ethylenically unsaturated mono- or dicarboxylic acid in polymerized form, a polymer 2 comprising 40% by weight of an α,β-ethylenically unsaturated mono- or dicarboxylic acid in polymerized form, and a polyol compound having at least two hydroxyl groups.

A priority-substantiating European patent application with application number 11154347.6, which was yet to be published at the priority date of the present application, discloses aqueous binders for granular and/or fibrous substrates, said binders comprising, as well as a polymer containing carboxylic acid groups and a polyol compound, essentially a salt compound. These salt-containing binder liquors have an advantageous effect on wet tear strength and the tear strength at 180° C. of the fiber nonwovens bonded therewith.

A priority-substantiating European patent application with application number 11159420.6, which was yet to be published at the priority date of the present application, likewise discloses aqueous binders for granular and/or fibrous substrates, said binders comprising, as well as a polymer containing carboxylic acid groups and a nitrogen-free polyol compound, essentially an organic nitrogen compound free of hydroxyl groups and having a pK_{B} of ≦7. The use of these binder liquors has an advantageous effect on wet tear strength and the color stability of the fiber webs bonded therewith.

In the case of use of the aforementioned binder systems, advantageous properties of the substrates bonded therewith, more particularly fiber webs, are achieved. However, the market is increasingly demanding less expensive binder systems, or binder systems which are produced using renewable raw materials. The market pressure for less expensive binder systems, or binder systems which are produced using renewable raw materials, is so strong that even somewhat worsened properties of the substrates bound with these binders are tolerated.

The state of the art in respect of polysaccharide-containing aqueous binder compositions is as follows.

EP-A 649 870 discloses mixtures of polycarboxylic acids and saccharide compounds in a weight ratio of 95:5 to 20:80 for production of polymer films with gas barrier action.

EP-A 911 361 discloses aqueous binder systems for granular and/or fibrous substrates, said binder systems comprising a polycarboxyl polymer with a weight-average molecular weight of at least 1000 g/mol and a polysaccharide with a weight-average molecular weight of at least 10 000 g/mol, the amounts of which are such that the equivalents ratio of carboxyl groups to hydroxyl groups is 3:1 to 1:20.

In addition, EP-A 1 578 879 discloses aqueous binder compositions for coating of glass fibers, comprising a polycarboxyl polymer, a polyalcohol with at least two hydroxyl groups, and a water-soluble extender, the water-soluble extenders proposed being particularly polysaccharides with a mean molecular weight less than 10 000 g/mol.

WO 2008/150647 discloses aqueous binder systems for production of fiber mats, comprising a urea-formaldehyde resin and an aqueous copolymer dispersion, the copolymer of which is formed essentially from styrene, alkyl acrylates or methacrylates, acrylonitrile and an optionally substituted acrylamide. The aqueous copolymer dispersion may optionally also comprise starch.

U.S.-A 2005/215153 discloses aqueous binder systems for glass fibers, said binder systems consisting of a “pre-binder composition” comprising a polycarboxyl polymer and a crosslinker, to which a dextrin or an appropriate dextrin derivative is added.

U.S.-A 2009/170978 also discloses aqueous binder systems for fiber webs, comprising an aqueous copolymer dispersion, the copolymer of which comprises between 5 and 40% by weight of at least one monomer containing carboxylic acid groups in copolymerized form, and a natural binder component selected from the group comprising polysaccharides, plant proteins, lignins and/or lignosulfonates.

A disadvantage of the prior art binder systems is that they are not always fully satisfactory in the production on shaped articles from granular and/or fibrous substrates, especially in terms of the mechanical properties thereof.

It was therefore an object of the present invention to provide aqueous binder compositions which can overcome the disadvantages of the prior art aqueous binder compositions, and which can make it possible to obtain shaped articles with improved tear strength or wet tear strength.

The object is achieved by an aqueous binder system obtainable by the process defined at the outset.

According to the invention, in the first process stage, ≧50 and ≦100 parts by weight, advantageously ≧85 and ≦100 parts by weight and especially advantageously 100 parts by weight of at least one monomer A1, and ≧0 and ≦50 parts by weight, advantageously ≧0 and ≦15 parts by weight and especially advantageously 0 parts by weight of at least one monomer A2, the total amounts of monomers A1 and A2 adding up to 100 parts by weight [total amount of monomers], are free-radically polymerized in an aqueous medium in the presence of ≧0.1 and ≦150% by weight, based on the total amount of monomers, of at least one saccharide compound B.

Monomers A1 are α,β-monoethylenically unsaturated, especially C₃ to C₆, preferably C₃ or C₄, mono- or dicarboxylic acids, and the fully or partly neutralized water-soluble salts thereof, especially the alkali metal or ammonium salts thereof. Examples include acrylic acid, methacrylic acid, ethacrylic acid, itaconic acid, allylacetic acid, crotonic acid, vinylacetic acid, fumaric acid, maleic acid, 2-methylmaleic acid, but also monoesters of ethylenically unsaturated dicarboxylic acids, such as monoalkyl maleates of C₁ to C₈-alcohols, and the ammonium, sodium or potassium salts of the aforementioned acids. The monomers A1 also include the anhydrides of corresponding α,β-monoethylenically unsaturated dicarboxylic acids, for example maleic anhydride or 2-methylmaleic anhydride. Monomer A1 is preferably selected from the group comprising acrylic acid, methacrylic acid, crotonic acid, fumaric acid, maleic acid, maleic anhydride, 2-methylmaleic acid and itaconic acid. Particularly advantageously in accordance with the invention, the monomers A1 used are, however, acrylic acid, methacrylic acid, maleic acid, maleic anhydride and/or itaconic acid.

Useful monomers A2 include all ethylenically unsaturated monomers which are different than the monomers A1 and are copolymerizable therewith. Examples of monomers A2 include vinylaromatic compounds, such as styrene, α-methylstyrene, o-chlorostyrene or vinyltoluenes, vinyl halides, such as vinyl chloride or vinylidene chloride, esters of vinyl alcohol and monocarboxylic acids having 1 to 18 carbon atoms, preferably 2 to 12 carbon atoms, such as vinyl acetate, vinyl propionate, vinyl n-butyrate, vinyl laurate and vinyl stearate, C₁ to C₁₂-alkyl vinyl ethers such as methyl vinyl ether, ethyl vinyl ether, n-propyl vinyl ether, n-butyl vinyl ether, n-pentyl vinyl ether, n-hexyl vinyl ether, esters of α,β-monoethylenically unsaturated mono- and dicarboxylic acids having preferably 3 to 6 carbon atoms, such as more particularly acrylic acid, methacrylic acid, maleic acid, fumaric acid and itaconic acid, with alkanols having generally 1 to 12, preferably 1 to 8 and especially 1 to 4 carbon atoms, such as particularly methyl acrylate and methacrylate, ethyl acrylate and methacrylate, n-butyl acrylate and methacrylate, isobutyl acrylate and methacrylate, pentyl acrylate and methacrylate, hexyl acrylate and methacrylate, heptyl acrylate and methacrylate, octyl acrylate and methacrylate, nonyl acrylate and methacrylate, decyl acrylate and methacrylate and 2-ethylhexyl acrylate and methacrylate, dimethyl fumarate and maleate or di-n-butyl fumarate and maleate, nitriles of α,β-monoethylenically unsaturated carboxylic acids, such as acrylonitrile, methacrylonitrile, fumaronitrile, maleonitrile and C₄₋₈ conjugated dienes such as 1,3-butadiene (butadiene) and isoprene. The aforementioned monomers form generally ≧50% by weight, preferably ≧80% by weight and especially preferably ≧90% by weight of the total amount of all monomers A2, and thus constitute the main monomers A2. Preferably in accordance with the invention, polymer A comprises, as main monomer A2, an ester of acrylic acid or methacrylic acid with a C₁ to C₁₂-alcohol, especially methyl acrylate, ethyl acrylate, n-butyl acrylate, 2-ethylhexyl acrylate or methyl methacrylate, a vinylaromatic compound, especially styrene, a nitrile of an α,β-monoethylenically unsaturated carboxylic acid, especially acrylonitrile, and/or a vinyl ester of a C₂ to C₁₂-monocarboxylic acid in polymerized form.

Further useful monomers A2, to a minor degree, are those ethylenically unsaturated monomers which comprise either at least one sulfo group and/or the corresponding anion thereof or at least one amino, amido, ureido or N-heterocyclic group and/or the nitrogen-protonated or -alkylated ammonium derivatives thereof. Examples include acrylamide and methacrylamide, and also vinylsulfonic acid, 2-acrylamido-2-methylpropanesulfonic acid, styrenesulfonic acid and the water-soluble salts thereof, and N-vinylpyrrolidone, 2-vinylpyridine, 4-vinylpyridine, 2-vinylimidazole, 2-(N,N-dimethylamino)ethyl acrylate, 2-(N,N-dimethylamino)ethyl methacrylate, 2-(N,N-diethylamino)ethyl acrylate, 2-(N,N-diethylamino)ethyl methacrylate, 2-(N-tert-butylamino)ethyl methacrylate, N-(3-N′,N′-dimethylaminopropyl)methacrylamide and 2-(1-imidazolin-2-onyl)ethyl methacrylate. The aforementioned monomers A2 are used generally in amounts of ≦10% by weight, preferably ≦8% by weight and especially ≦5% by weight, based in each case on the total amount of monomers A2. The preferred monomer used is acrylamide and/or methacrylamide in an amount of ≧0.5 and ≦4% by weight, based on the total amount of monomers A2.

Monomers A2 which typically increase the integrity of the films formed by a polymer matrix normally have at least one epoxy group, at least one carbonyl group, or at least two nonconjugated ethylenically unsaturated double bonds. Examples thereof are monomers having two vinyl radicals, monomers having two vinylidene radicals, and monomers having two alkenyl radicals. Particularly advantageous are the diesters of dihydric alcohols with α,β-monoethylenically unsaturated monocarboxylic acids, among which preference is given to acrylic acid and methacrylic acid. Examples of such monomers having two nonconjugated ethylenically unsaturated double bonds are alkylene glycol diacrylates and dimethacrylates, such as ethylene glycol diacrylate, 1,2-propylene glycol diacrylate, 1,3-propylene glycol diacrylate, 1,3-butylene glycol diacrylate, 1,4-butylene glycol diacrylate and ethylene glycol dimethacrylate, 1,2-propylene glycol dimethacrylate, 1,3-propylene glycol dimethacrylate, 1,3-butylene glycol dimethacrylate, 1,4-butylene glycol dimethacrylate, and divinylbenzene, vinyl methacrylate, vinyl acrylate, allyl methacrylate, allyl acrylate, diallyl maleate, diallyl fumarate, methylenebisacrylamide, cyclopentadienyl acrylate, triallyl cyanurate or triallyl isocyanurate. The aforementioned monomers A2 are used generally in amounts of ≦10% by weight, preferably ≦5% by weight and especially ≦2% by weight, based in each case on the total amount of monomers A2. The monomers A2 used are preferably, however, methyl acrylate, ethyl acrylate, n-butyl acrylate, 2-ethylhexyl acrylate, methyl methacrylate and/or styrene.

Preference is given to polymerization using ≧85 and ≦100% by weight of at least one monomer A1, and ≧0 and ≦15% by weight of at least one monomer A2. Particularly advantageously, polymerization is accomplished using ≧85 and ≦100% by weight of acrylic acid, methacrylic acid, maleic acid, maleic anhydride and/or itaconic acid, especially advantageously acrylic acid, and acrylic acid and maleic anhydride, and ≧0 and ≦15% by weight of methyl acrylate, ethyl acrylate, n-butyl acrylate, 2-ethylhexyl acrylate, methyl methacrylate and/or styrene.

Especially advantageously, however, exclusively monomers Al are used for polymerization, preference being given to acrylic acid, methacrylic acid, maleic acid, maleic anhydride and/or itaconic acid, and particular preference to acrylic acid or mixtures of acrylic acid and maleic anhydride.

It is essential to the process according to the invention that the free-radical polymerization of monomers A1 and A2 is effected in an aqueous medium in the presence of at least one saccharide compound B.

In the context of this document, a saccharide compound B is understood to mean the following saccharide compounds familiar to those skilled in the art: monosaccharides, oligosaccharides, polysaccharides, sugar alcohols and substitution products and derivatives of the aforementioned compounds.

The monosaccharides are organic compounds of the general formula CₙH₂ₙOₙ where n is an integer of 5, 6, 7, 8 or 9. These monosaccharides are also referred to as pentoses, hexoses, heptoses, octoses or nonoses, and these compounds can be subdivided into the corresponding aldoses which have an aldehyde group, and ketoses which have a keto group. Accordingly, the monosaccharides comprise aldo- or ketopentoses, -hexoses, -heptoses, -octoses or -nonoses. Monosaccharide compounds preferred in accordance with the invention are the pentoses and hexoses which also occur in nature, special preference being given to glucose, mannose, galactose and/or xylose. It will be appreciated that the invention also comprises all stereoisomers of all aforementioned monosaccharides.

The sugar alcohols are the hydrogenation products of the aforementioned aldo- or ketopentoses, -hexoses, -heptoses, -octoses or -nonoses which have the general formula CₙH₂ₙ₊₂Oₙ where n is an integer of 5, 6, 7, 8 or 9. Preferred sugar alcohols are mannitol, lactitol, sorbitol and/or xylitol. It will be appreciated that the invention also comprises all stereoisomers of all aforementioned sugar alcohols.

It is known that the aforementioned monosaccharides are present in the form of the hemiacetals or -ketals thereof, formed from a hydroxyl group and the aldehyde or keto group, generally forming a five- or six-membered ring. If a hydroxyl group (from the hemiacetal or hemiketal group or from the carbon skeleton chain) of one monosaccharide molecule then reacts with the hemiacetal or hemiketal group of another monosaccharide molecule with elimination of water to form an acetal or ketal group (such a bond is also called a glycosidic bond), this affords disaccharides (with the general empirical formula CₙH₂ₙ₋₂Oₙ₋₁). In addition, such a disaccharide can react with a further monosaccharide with elimination of water to give a trisaccharide. Further reactions with monosaccharides afford tetrasaccharides, pentasaccharides, hexasaccharides, heptasaccharides, octasaccharides, nonasaccharides or decasaccharides. Compounds formed from at least two but not more than ten monosaccharide structural units via glycosidic bonds are referred to in the context of this document as oligosaccharides. Preferred oligosaccharides are the disaccharides, among which particular preference is given to lactose, maltose and/or sucrose. It will be appreciated that the invention also encompasses all stereoisomers of all aforementioned oligosaccharides.

Saccharide compounds formed from more than ten monosaccharide structural units are referred to in the context of this document as polysaccharide compounds. The polysaccharide compounds may be formed from the structural elements of a monosaccharide (called homoglycans) or the structural elements of two or more different monosaccharides (called heteroglycans). Preference is given in accordance with the invention to using homoglycans.

Among the homoglycans, special preference is given to the starches formed from a-D-glucose units. The starches consist of the polysaccharides amylose (D-glucose units, α-1,4-glycosidically bonded to one another) and amylopectin (D-glucose units, α-1,4- and additionally about 4% α-1,6-glycosidically bonded to one another). Typically, naturally occurring starch comprises about 20 to 30% by weight of amylose and about 70 to 80% by weight of amylopectin. By breeding, and varying according to the plant type, the ratio between amylose and amylopectin may, however, be altered. Suitable starches are all native starches, for example starches from corn, wheat, oats, barley, rice, millet, potatoes, peas, tapioca, sorghum or sago. Also of interest are those natural starches which have a high amylopectin content, such as waxy corn starch and waxy potato starch. The amylopectin content of these starches is ≧90% by weight, often ≧95% and ≦100% by weight.

It will be appreciated that the term “saccharide compound B” also comprises the substitution products and derivatives of the aforementioned mono-, oligo- and polysaccharide compounds, and of the sugar alcohols.

The substitution products of a saccharide compound B are those in which at least one hydroxyl group of the saccharide compound B has been functionalized with retention of the saccharide structure, for example by esterification, etherification, oxidation, etc. The esterification is effected, for example, by reaction of the saccharide compound B with inorganic or organic acids, or the anhydrides or halides thereof. Of particular interest are phosphated and acetylated saccharide compounds. The etherification is effected generally by reaction of the saccharide compounds with organic halogen compounds, epoxides or sulfates in aqueous alkaline solution. Known ethers are alkyl ethers, hydroxyalkyl ethers, carboxyalkyl ethers and allyl ethers. The oxidation of at least one hydroxyl group by means of an oxidizing agent customary in organic carbohydrate chemistry, for example nitric acid, hydrogen peroxide, ammonium persulfate, peroxyacetic acid, sodium hypochlorite and/or 2,2,6,6-tetramethyl-1-piperidinyloxy (TEMPO) gives rise to the corresponding keto compound (in the case of oxidation of a secondary hydroxyl group), or carboxyl compound (in the case of oxidation of a primary hydroxyl group).

Derivatives of saccharide compounds B are understood to mean those reaction products of oligo- and polysaccharides which are obtained with cleavage of at least one acetal or ketal group (i.e. of at least one glycosidic bond) and therefore with degradation of the original saccharide structure. Such degradation reactions are familiar to those skilled in the art and are effected, more particularly, by subjecting an oligo- or polysaccharide compound to thermal, microbial, enzymatic, oxidative and/or hydrolytic conditions.

Advantageously, the saccharide compounds B used are starch, cellulose, guaran, xanthan, alginate, pectin, chitosan, gum arabic, carrageenan, agar, gellan and derivatives and/or substitution products thereof.

Particularly advantageously, however, starch and derivatives and/or substitution products thereof are used, particular preference being given to maltodextrin and/or glucose syrup, or hydrolytically degraded starches.

The saccharide compounds B generally have a weight-average molecular weight in the range of ≧1000 and ≦5 000 000 g/mol, advantageously in the range of ≧1000 and ≦500 000 g/mol, preferably in the range of ≧3000 and ≦50 000 g/mol and especially preferably in the range of ≧3000 and ≦10 000 g/mol or ≧3000 and ≦8000 g/mol. The weight-average molecular weight is determined by means of gel permeation chromatography, which is familiar to those skilled in the art, with defined standards.

A very familiar parameter in commercial practice for characterization of the degradation level of starches is the DE value. DE stands for Dextrose Equivalent, and refers to the percentage of reducing sugars in the dry substance. The DE value therefore corresponds to the amount of glucose (=dextrose) in grams which would have the same reduction capacity per 100 g of dry substance. The DE value is a measure of the extent of polymer degradation. Therefore, starches with low DE value maintain a high proportion of polysaccharides and a low content of low molecular weight mono- and oligosaccharides, while starches with a high DE value consist principally of low molecular weight mono- or disaccharides. The maltodextrins, which are preferred in the context of the present invention, have DE values in the range from 3 to 20 and weight-average molecular weights of 15 000 to 20 000 g/mol. A glucose syrup, which is likewise preferred in the context of the present invention, has DE values of 20 to 30 and weight-average molecular weights in the range from 3000 to 6000 g/mol. By virtue of their preparation, these products are obtained in the form of aqueous solutions and are therefore generally also traded as such. Suitable solutions of maltodextrins have solids contents of 50 to 70% by weight, suitable solutions of glucose syrup have solids contents of 70 to 95% by weight. Maltodextrins in particular, however, are also available in spray-dried form as powders. Also preferred in accordance with the invention are modified degraded starches which have DE values of 1 to 3 and weight-average molecular weights Mw of 50 000 to 500 000 g/mol, and are typically obtainable as solids.

It is preferable when the saccharide compounds B used in accordance with the invention have a solubility of 10 g, advantageously 50 g and especially advantageously 100 g per liter of deionized water at 20° C. and atmospheric pressure [1 atm=1.013 bar (absolute)]. The invention, however, shall also comprise embodiments where the saccharide compounds B have a solubility of <10 g per liter of deionized water at 20° C. and atmospheric pressure. Depending on the amount of these saccharide compounds B used, they may then also be present in the form of aqueous suspensions thereof. When saccharide compounds B, in terms of nature and amount, are used in accordance with the invention such that they are present in aqueous suspension, it is advantageous when the particles of the saccharide compound B suspended in aqueous medium have a mean particle diameter of ≦5 μm, preferably ≦3 μm and especially preferably ≦1 μm. The mean particle diameters are determined via the method of quasielastic light scattering (ISO Standard 13 321).

It is essential to the invention that at least a portion of the at least one saccharide compound B is initially charged in the aqueous medium before initiation of the polymerization reaction, and any remaining portion of the at least one saccharide compound B is added during the polymerization reaction batchwise in one or more portions, or continuously with varying or constant flow rates. Advantageously ≧50% by weight, particularly advantageously ≧90% by weight, of the total amount, and especially advantageously the entirety of the at least one saccharide compound B is initially charged in the aqueous medium.

According to the invention, the amount of saccharide compound B is ≧0.1 and ≦150% by weight, advantageously ≧30 and ≦100% by weight and especially advantageously ≧40 and ≦70% by weight, based in each case on the total amount of monomers.

The free-radical polymerization of monomers A1 and A2 is familiar to those skilled in the art and is effected, more particularly, by the method of free-radical emulsion, solution or suspension polymerization. Preferably, however, the free-radical polymerization is effected by free-radically initiated aqueous emulsion polymerization and by free-radically initiated solution polymerization in an aqueous medium. The free-radically initiated aqueous emulsion polymerization is effected especially when the monomer mixture used for polymerization comprises monomer A2 in such amounts that a separate monomer phase forms in the aqueous polymerization medium.

The performance of free-radically initiated emulsion polymerizations of ethylenically unsaturated monomers in an aqueous medium has been described many times before and is therefore sufficiently well-known to the person skilled in the art [in this regard, cf. Emulsion Polymerisation in Encyclopedia of Polymer Science and Engineering, vol. 8, pages 659 ff. (1987); D. C. Blackley, in High Polymer Latices, vol. 1, pages 35 ff. (1966); H. Warson, The Applications of Synthetic Resin Emulsions, chapter 5, pages 246 ff. (1972); D. Diederich, Chemie in unserer Zeit 24, pages 135 to 142 (1990); Emulsion Polymerisation, Interscience Publishers, New York (1965); DE-A 40 03 422 and Dispersionen synthetischer Hochpolymerer [Dispersions of Synthetic High Polymers], F. Holscher, Springer-Verlag, Berlin (1969)]. The free-radically initiated aqueous emulsion polymerization reactions are typically effected in such a way that the ethylenically unsaturated monomers are dispersed using dispersing aids in the form of monomer droplets in the aqueous medium and polymerized by means of a free-radical polymerization initiator to form aqueous polymer dispersions.

Free-radically initiated solution polymerization is also familiar to those skilled in the art and is effected especially in water or a water/solvent mixture (see, for example, A. Echte, Handbuch der Technischen Polymerchemie [Handbook of Industrial Polymer Chemistry], chapter 6, VCH, Weinheim, 1993 or B. Vollmert, Grundriss der Makromolekularen Chemie [Elements of Macromolecular Chemistry], volume 1, E. Vollmert Verlag, Karlsruhe, 1988; L. Kotzeva, J. Polym. Sci. A-27, 1989 (4), pages 1325ff; C. Erbil et al., Polymer 41, 2000, pages 1391ff; C. Yang, X. Lu Yun, J. Polym. Sci. 75(2), 2000, pages 327ff; M. Sen et al., Polymer 40(9), 1999, pages 913ff; F. Wang et al., Anal. Chem. 68, 1996, pages 2477ff; J. Velada et al., Macromol. Chem. and Phys. 196, 1995, pages 3171ff; J. M. Cowie, C. Haq, Br. Polym. J. 9, 1977, pages 241ff; J. Velada et al., Polymer Degradation and Stability 52, 1996, pages 273ff; A. Horta et al., Makromol. Chem., Rapid Commun. 8, 1987, pages 523ff; T. Hirano et al., J. Polym. Sci. A-38, 2000, pages 2487ff; B. E. Tate, Adv. Polymer Sci. 5, 1967, pages 214ff). If the polymerization is effected in a water/solvent mixture, the organic solvent after completion of the polymerization reaction is generally removed at least partly, advantageously to an extent of ≧50% by weight or ≧90% by weight, and especially advantageously completely. The corresponding processes are familiar to those skilled in the art.

When organic solvents are used, it is advantageous to select those solvents which have unlimited miscibility with water at 20° C. and atmospheric pressure, for example aliphatic C₁-C₅-alcohols, such as more particularly methanol, ethanol, n-propanol or isopropanol, or aliphatic C₁-C₅-ketones, such as more particularly acetone or butanone.

Particularly advantageously, the polymerization reaction is effected by free-radically initiated solution polymerization in an aqueous solvent-free medium, especially in deionized water. The amount of water is selected such that it is ≧40 and ≦900% by weight, advantageously ≧60 and ≦700% by weight and especially advantageously ≧80 and ≦500% by weight, based in each case on the total amount of monomers.

Accordingly, a polymerization vessel is initially charged with at least a portion of the water and at least a portion of the saccharide compound B and optionally a portion of monomers A1 and A2 prior to initiation of the polymerization reaction, and following the initiation of the polymerization reaction any remaining residual amounts of water, saccharide compound B and the entirety or any remaining residual amount of monomers A1 and A2 are metered into the aqueous polymerization medium under polymerization conditions, batchwise in one or more portions or continuously with constant or varying flow rates. Particularly advantageously, however, at least a portion, advantageously ≧50% by weight and especially advantageously ≧75% by weight of monomers A1 and A2, are supplied continuously to the aqueous medium under polymerization conditions.

The initiation of the free-radical polymerization is effected by means of a free-radical polymerizatibn initiator (free-radical initiator). This may in principle comprise either peroxides or azo compounds. It will be appreciated that redox initiator systems are also an option. The peroxides used may in principle be inorganic peroxides, such as hydrogen peroxide or peroxodisulfates, such as the mono- or di-alkali metal or ammonium salts of peroxodisulfuric acid, for example the mono- and disodium, -potassium or ammonium salts thereof, or organic peroxides, such as alkyl hydroperoxides, for example tert-butyl, p-menthyl or cumyl hydroperoxide, and dialkyl or diaryl peroxides, such as di-tert-butyl or dicumyl peroxide. The azo compounds used are essentially 2,2′-azobis(isobutyronitrile), 2,2′-azobis(2,4-dimethylvaleronitrile) and 2,2′-azobis(amidinopropyl) dihydrochioride (AIBA, corresponds to V-50 from Wako Chemicals). Useful oxidizing agents for redox initiator systems include essentially the abovementioned peroxides. Corresponding reducing agents used may be sulfur compounds of low oxidation state, such as alkali metal sulfites, for example potassium sulfite and/or sodium sulfite, alkali metal hydrogensulfites, for example potassium hydrogensulfite and/or sodium hydrogensulfite, alkali metal metabisulfites, for example potassium metabisulfite and/or sodium metabisulfite, formaldehydesulfoxylates, for example potassium formaldehydesulfoxylate and/or sodium formaldehydesulfoxylate, alkali metal salts, especially potassium and/or sodium salts of aliphatic sulfinic acids and alkali metal hydrogensulfides, for example potassium hydrogensulfide and/or sodium hydrogensulfide, salts of polyvalent metals, such as iron(II) sulfate, iron(II) ammonium sulfate, iron(II) phosphate, enediols such as dihydroxymaleic acid, benzoin and/or ascorbic acid. In general, the amount of the free-radical initiator used, based on the total amount of monomers, is 0.01 to 5% by weight, preferably 0.1 to 3% by weight and especially preferably 0.2 to 1.5% by weight.

According to the invention, the total amount of the free-radical initiator can be initially charged in the aqueous polymerization medium prior to initiation of the polymerization reaction. However, it is also possible optionally to initially charge merely a portion of the free-radical initiator in the aqueous polymerization medium prior to initiation of the polymerization reaction and then to add the entirety or any remaining amount under polymerization conditions at the rate of consumption, batchwise in one or more portions or continuously with constant or varying flow rates.

Initiation of the polymerization reaction is understood to mean the start of the polymerization reaction of the monomers present in the aqueous polymerization medium after the free-radical initiator has formed free radicals. The polymerization reaction can be initiated by addition of free-radical initiator to the aqueous polymerization medium under polymerization conditions. However, it is also possible that a portion or the entirety of the free-radical initiator is added to the aqueous polymerization medium comprising the initially charged saccharide compound B and optionally monomers A1 and A2 under conditions unsuitable for triggering a polymerization reaction, for example at low temperature, and then polymerization conditions are established in the aqueous polymerization medium. Polymerization conditions are generally understood to mean those temperatures and pressures under which the free-radical initiated polymerization proceeds at sufficient polymerization rate. They depend particularly on the free-radical initiator used. Advantageously, the type and amount of the free-radical initiator, polymerization temperature and polymerization pressure are selected such that a sufficient amount of initiating radicals is always present to initiate or to maintain the polymerization reaction.

Useful reaction temperatures for the inventive free-radically initiated polymerization are the entire range from 0 to 170° C. In general, temperatures of 50 to 120° C., frequently 60 to 110° C. and often 70 to 100° C. are employed. The inventive free-radically initiated polymerization can be performed at a pressure less than, equal to or greater than 1 atm (atmospheric pressure), and so the polymerization temperature may exceed 100° C. and be up to 170° C. In this case, the pressure may be 1.2, 1.5, 2, 5, 10, 15 bar (absolute), or assume even higher values. When the polymerization reaction is performed under reduced pressure, pressures of 950 mbar, frequently of 900 mbar and often 850 mbar (absolute) are established. Advantageously, the inventive free-radically initiated polymerization is performed at 1 atm or at a higher pressure with exclusion of oxygen, for example under inert gas atmosphere, for example under nitrogen or argon.

It is essential that, in the inventive polymerization reactions, as well as the aforementioned feedstocks, it is also possible to use further customary components, for example surfactants or protective colloids in the case of an emulsion polymerization, or what are called free-radical chain-transferring compounds to control the molecular weight of the polymers obtainable by the emulsion polymerization and in the solution polymerization.

Particularly advantageously, the process according to the invention is effected in such a way that monomers A1 and A2 are converted in the first process stage up to a conversion of ≧95% by weight, advantageously ≧98% by weight and especially advantageously ≧99% by weight. It is frequently advantageous when the aqueous polymerization mixture obtained on completion of the polymerization reaction is subjected to an aftertreatment to reduce the residual monomer content. The aftertreatment is effected either chemically, for example by completion of the polymerization reaction by using a more effective free-radical initiator system (called postpolymerization), and/or physically, for example by stripping the aqueous polymerization mixture with steam or inert gas. Corresponding chemical and/or physical methods are familiar to those skilled in the art [see, for example, EP-A 771328, DE-A 19624299, DE-A 19621027, DE-A 19741184, DE-A 19741187, DE-A 19805122, DE-A 19828183, DE-A 19839199, DE-A 19840586 and 19847115]. The combination of chemical and physical aftertreatment gives the advantage that not only the unconverted monomers A1 and A2 but also other troublesome volatile organic constituents [called VOCs [volatile organic compounds]) are removed from the aqueous polymerization mixture.

On completion of the polymerization reaction and any aftertreatment, the resulting aqueous polymerization mixture can be adjusted to a solids content of 30 and 60% by weight by addition or removal of water.

According to the invention, ≧0.1 and ≦70% by weight, preferably 10 and 5-50% by weight and especially preferably ≧20 and ≦40% by weight, based in each case on the total amount of monomers, of at least one alkanolamine C is added to the polymerization mixture obtained in the first process stage.

The alkanolamines C used are especially compounds of the general formula (I)

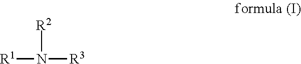

in which R¹ is a hydrogen atom, a C₁-C₁₀-alkyl group or a C₂-C₁₀-hydroxyalkyl group, and R² and R³ are each a C₂-C₁₀-hydroxyalkyl group.

More preferably, R² and R³ are each independently a C₂-C₅-hydroxyalkyl group, and R¹ is a hydrogen atom, a C₁-C₅-alkyl group or a C₂-C₅-hydroxyalkyl group.

The alkanolamines C used are, however, especially advantageously diethanolamine, triethanolamine, diisopropanolamine, triisopropanolamine, methyldiethanolamine, butyldiethanolamine and/or methyldiisopropanolamine, special preference being given to triethanolamine.

In general, the total amount of the at least one alkanolamine C is added to the aqueous polymerization mixture obtained in the first process stage at a temperature of ≧0 and ≦70° C. and advantageously ≧10 and ≦50° C., batchwise in one or more portions or continuously at constant or varying flow rates, and the mixture obtained is mixed homogeneously.

The inventive aqueous binder system may comprise phosphorus-containing reaction accelerators, the total amount of which is preferably ≦5% by weight, frequently ≦1.0% by weight, often ≦0.5% by weight, and frequently ≧0.1% by weight and often ≧0.3% by weight, based on the sum of the total amounts of monomers A1, monomers A2 and alkanolamines C (solid/solid). Phosphorus-containing reaction accelerators are disclosed, for example, in EP-A 583086 and EP-A 651088. These are especially alkali metal hypophosphites, phosphites, polyphosphates and dihydrogenphosphates, polyphosphoric acid, hypophosphoric acid, phosphoric acid, alkyiphosphinic acid, or oligomers or polymers of these salts and acids.

However, the inventive aqueous binder systems preferably do not comprise any phosphorus-containing reaction accelerators or any amounts of a phosphorus-containing compound effective for acceleration of reaction. The inventive binder systems may, however, comprise esterification catalysts familiar to those skilled in the art, for example sulfuric acid or p-toluenesulfonic acid, or titanates or zirconates.

In addition, the inventive aqueous binder systems may also comprise further optional auxiliaries familiar to the person skilled in the art in terms of type and amount, for example what are called thickeners, defoamers, neutralizing agents, buffer substances, preservatives, finely divided inert fillers, such as aluminum silicates, quartz, precipitated or fumed silica, light or heavy spar, talc or dolomite, coloring pigments such as titanium white, zinc white or iron oxide black, adhesion promoters and/or flame retardants.

If an inventive aqueous binder system is to be used as a binder for mineral fibers and/or glass fibers or webs produced therefrom, it is advantageous to add to the aqueous binder system ≧0.001 and ≦5% by weight and especially advantageous to add ≧0.05 and ≦2% by weight, based on the sum of the total amounts of monomers A1, monomers A2 and alkanolamines C (solid/solid), of at least one silicon-containing organic compound (adhesion promoter), for example of an alkoxysilane, such as methyltrimethoxysilane, n-propyltrimethoxysilane, n-octyltrimethoxysilane, n-decyltriethoxysilane, n-hexadecyltrimethoxysilane, dimethyldimethoxysilane, trimethylmethoxysilane, 3-acetoxypropyltrimethoxysilane, 3-aminopropyltrimethoxysilane, 3-aminopropyltriethoxysilane, 3-chloropropyltrimethoxysilane, (3-glycidyloxypropyl)trimethoxysilane, 3-mercaptopropyltrimethoxysilane and/or phenyltrimethoxysilane, particular preference being given to adding functionalized alkoxysilanes such as 3-acetoxypropyltrimethoxysilane, 3-aminopropyltrimethoxysilane, 3-aminopropyltriethoxysilane, 3-chloropropyltrimethoxysilane, (3-glycidyloxypropyl)trimethoxysilane and/or 3-mercaptopropyltrimethoxysilane.

The inventive aqueous binder systems typically have solids contents (formed from the sum of the total amount of monomers A1, monomers A2, saccharide compound B and alkanolamine C, calculated as solids) of ≧1 and ≦70% by weight, frequently ≧5 and ≦65% by weight and often ≧10 and ≦55% by weight, based in each case on the aqueous binder system.

The inventive aqueous binder systems typically have pH values (measured at 23° C.; diluted with deionized water to a solids content of 10% by weight) in the range of ≧1 and ≦10, advantageously ≧2 and ≦6 and especially advantageously ≧3 and ≦5. The pH can be adjusted using all basic compounds familiar to those skilled in the art. Frequently, however, the basic compounds used are those which are nonvolatile at the temperatures during drying or curing, for example sodium hydroxide, potassium hydroxide or sodium carbonate.

The aforementioned aqueous binder systems are advantageously suitable for production of adhesives, sealants, synthetic renders, paper coating slips, shaped articles, paints and impact modifiers, and for modification of mineral binders and polymers.

However, the aforementioned aqueous binder systems are especially advantageous as binders for fibrous and/or granular substrates. The aqueous binder systems mentioned can therefore be used advantageously for production of shaped articles of fibrous and/or granular substrates.

Granular and/or fibrous substrates are familiar to those skilled in the art. For example, these are woodchips, wood fibers, cellulose fibers, textile fibers, synthetic fibers, glass fibers, mineral fibers, or natural fibers such as jute, flax, hemp or sisal, but also cork chips, sand and other organic or inorganic, natural and/or synthetic, granular and/or fibrous compounds, whose longest dimension in the case of granular substrates is ≦10 mm, preferably ≦5 mm and especially ≦2 mm. It will be appreciated that the term “substrate” shall also comprise the fiber webs obtainable from fibers, for example what are called mechanically consolidated (for example needled) or chemically prebonded fiber webs, prebonded for example with melamine/formaldehyde resins or polyvinyl alcohol. The inventive aqueous binder system is especially advantageous as a formaldehyde-free binder for the aforementioned fibers or fiber webs formed therefrom.

The process for producing a shaped article from a granular and/or fibrous substrate and the inventive aqueous binder system is advantageously effected in such a way that the inventive aqueous binder system is applied homogeneously to the granular and/or fibrous substrates, or the granular and/or fibrous substrates are impregnated with the inventive aqueous binder system, the granular and/or fibrous substrates treated with the aqueous binder system are optionally shaped, and the treated granular and/or fibrous substrates are subsequently subjected to a thermal treatment step at a temperature of ≧110° C.

The treatment (impregnation) of the granular and/or fibrous substrates with the inventive aqueous binder system is generally effected in such a way that the aforementioned aqueous binder system is applied homogeneously to the surface of the granular and/or fibrous substrates. The amount of aqueous binder system is selected such that ≧0.1 g and ≦100 g, preferably ≧1 g and ≦50 g and especially preferably ≧5 g and ≦30 g of binder (calculated as the sum of the total amounts of monomers A1, monomers A2, saccharide compounds B and alkanolamines C based on solids) are used per 100 g of granular and/or fibrous substrate. The impregnation of the granular and/or fibrous substrates is familiar to those skilled in the art and is effected, for example, by soaking or by spraying the granular and/or fibrous substrates.

After the application of the aqueous binder system, the granular and/or fibrous substrate is optionally converted to the desired shape, for example by introduction into a heatable press or mold. Thereafter, the shaped impregnated granular and/or fibrous substrate is dried and cured in a manner familiar to those skilled in the art.

Frequently, the drying or curing of the optionally shaped, impregnated granular and/or fibrous substrate is effected in two temperature stages, in which case the drying stage is effected at a temperature of <110° C., preferably ≧20° C. and ≦100° C. and especially preferably ≧40 and ≦100° C., and the curing stage at a temperature of ≧110° C., frequently ≧130 and ≦250° C. or ≧160 and ≦220° C., and especially preferably ≧170° C. and ≦210° C.

The drying stage is advantageously effected in such a way that drying is continued at a temperature of <100° C. until the shaped impregnated granular and/or fibrous substrate, which frequently is still not in its final shape (called semifinished product), has a residual moisture content of ≦30% by weight, preferably ≦15% by weight and especially preferably ≦10% by weight. The residual moisture content is generally determined by weighing about 1 g of the resulting semifinished product at room temperature, then drying it at 110° C. for 2 minutes and then cooling it and weighing it again at room temperature. The residual moisture content corresponds to the difference in weight of the semifinished product before and after the drying operation at 110° C., based on the weight of the semifinished product before the drying operation multiplied by a factor of 100.

The semifinished product thus obtained is still deformable by heating to a temperature up to approx. 100° C. (thermoplastic behavior) and can be converted to the final shape of the desired shaped article at this temperature.

The subsequent curing stage is advantageously effected in such a way that the semifinished product is heated at a temperature of ≧110° C. until it has a residual moisture content of ≦2% by weight, preferably ≦1% by weight or ≦0.5% by weight and especially preferably ≦0.1% by weight, the binder curing as a result of a chemical esterification reaction (thermoset behavior).

Frequently, the shaped articles are produced by converting the semifinished product to the final shape and then curing it in a mold press within the aforementioned temperature ranges.

It will be appreciated that it is also possible that the drying stage and the curing stage of the moldings are effected in one step, for example in a mold press.

The shaped articles obtainable by the process according to the invention, especially fiber webs, have advantageous properties, more particularly improved tear resistance or wet tear resistance, compared to the prior art shaped articles.

The invention is to be illustrated by the nonrestrictive examples which follow.

### EXAMPLES

### A) Preparation of the Polymer Systems

### Polymer System 1

A 2 l glass flask equipped with a stirrer and metering devices was initially charged at 20 to 25° C. (room temperature) and under a nitrogen atmosphere with 420 g of deionized water, 127 g of maleic anhydride, 313 g of a hydrolytically degraded starch with a DE value of 28 (purity 96% by weight; Maltosweet® 300 from Tate and Lyle GmbH) and 7 mg of iron(II) sulfate heptahydrate, and heated to 99° C. with stirring at atmospheric pressure. On attainment of this temperature, beginning simultaneously, 803 g of a 56% by weight aqueous solution of acrylic acid were metered in within 4 hours, and 138 g of a 16% by weight aqueous solution of hydrogen peroxide within 5 hours, continuously at constant flow rates and while stirring and maintaining the aforementioned temperature. Subsequently, the polymerization mixture was allowed to continue polymerization at the aforementioned temperature for another 2 hours, and cooled to room temperature. The resulting aqueous polymer solution had a solids content of 49.5% by weight. The viscosity was determined to be 602 mPas (spindle 2, 30 revolutions per minute [rpm]).

The solids contents were generally determined by drying a defined amount of the aqueous polymer solution (approx. 0.8 g) to constant weight (about 2 hours) at a temperature of 130° C. with the aid of the Mettler Toledo HR73 moisture analyzer. Two measurements were conducted in each case. The value reported in each case is the mean of these measurements.

The viscosities were generally determined by means of a Brookfield viscometer, LVF model, at 25° C. to ISO 2555 (1989).

### Polymer System 2

Polymer system 2 was prepared analogously to the preparation of polymer system 1, except that 579 g rather than 420 g of deionized water and 417 g of a 72% by weight aqueous solution of a hydrolytically degraded starch with a DE value of 26 to 32 (C*Sweet 01403 from Cargill GmbH) rather than 313 g of Maltosweet® were initially charged, and 540 g of an 83% by weight aqueous solution of acrylic acid rather than 803 g of a 56% by weight aqueous solution of acrylic acid were metered in.

The resulting aqueous polymer solution had a solids content of 50.2% by weight. The viscosity was determined to be 513 mPas (spindle 3, 30 rpm).

### Polymer System 3

The preparation of polymer system 3 was effected analogously to the preparation of polymer system 1, except that 442 g rather than 420 g of deionized water, 95 g rather than 127 g of maleic anhydride and 469 g rather than 313 g of Maltosweet® were initially charged, and 676 g of a 50% by weight aqueous solution rather than 803 g of a 56% by weight aqueous solution of acrylic acid and 120 g of a 13.8% by weight aqueous solution rather than 138 g of a 16% aqueous solution of hydrogen peroxide were metered in.

The resulting aqueous polymer solution had a solids content of 50.2% by weight. The viscosity was determined to be 212 mPas (spindle 3, 60 rpm).

### Polymer System 4

The preparation of polymer system 4 was effected analogously to the preparation of polymer system 2, except that 286 g rather than 579 g of deionized water, 95 g rather than 127 g of maleic anhydride and 625 g rather than 417 g of C*Sweet 01403 were initially charged, and 676 g of a 50% by weight aqueous solution rather than 803 g of a 56% by weight aqueous solution of acrylic acid and 120 g of a 13.8% by weight aqueous solution rather than 138 g of a 16% aqueous solution of hydrogen peroxide were metered in.

The resulting aqueous polymer solution had a solids content of 49.7% by weight. The viscosity was determined to be 190 mPas (spindle 2, 60 rpm).

### Comparative Polymer C

The comparative polymer C used was a 47% by weight aqueous solution of an acrylic acid/maleic acid polymer (acrylic acid/maleic acid in a weight ratio of 75:25) with a weight-average molecular weight of 87 000 g/mol.

### B) Performance Tests

### Production of the Binder Liquors

The binder liquors were produced by adjusting the aqueous polymer systems 1 to 4 to a solids content of 45% by weight by diluting with deionized water at room temperature. Thereafter, 100 g portions were taken from each of the diluted aqueous polymer systems 1 to 4, and each was admixed with the amounts of triethanolamine specified in table 1 while stirring.

To produce the comparative binder liquors, 122 g or 244 g of Maltosweet® 300 or 163 g or 326 g of C*Sweet 01403 were added while stirring to 500 g in each case of comparative polymer C at room temperature. By subsequently adding the deionized water, the resulting solutions were adjusted to a solids content of 45% by weight. The dilute solutions obtained correspondingly are referred to as polymer systems C1 and C3, and C2 and C4 respectively. Thereafter, 100 g portions were taken from each of the resulting polymer systems C1 to C4, and each was admixed with the amounts of triethanolamine likewise specified in table 1 while stirring.

TABLE 1
Added amounts of triethanolamine and resulting polymer systems

| Polymer system used | Amount of triethanol- | Resulting |
|---|---|---|
| [No.] | amine [in g] | polymer system [No.] |
| 1 | 3.0 | 1.1 |
| 1 | 6.0 | 1.2 |
| 1 | 9.0 | 1.3 |
| 1 | 12.0 | 1.4 |
| 2 | 6.0 | 2.1 |
| 2 | 9.0 | 2.2 |
| 3 | 4.5 | 3.1 |
| 3 | 6.8 | 3.2 |
| 4 | 4.5 | 4.1 |
| 4 | 6.8 | 4.2 |
| C1 | 3.0 | C1.1 |
| C1 | 6.0 | C1.2 |
| C1 | 9.0 | C1.3 |
| C1 | 12.0 | C1.4 |
| C2 | 6.0 | C2.1 |
| C2 | 9.0 | C2.2 |
| C3 | 4.5 | C3.1 |
| C3 | 6.8 | C3.2 |
| C4 | 4.5 | C4.1 |
| C4 | 6.8 | C4.2 |

The resulting polymer systems 1.1 to C4.2 were subsequently each admixed with 0.16 g of 3-aminopropyltriethoxysilane (Silquest® A-1100® silane from Momentive Performance Materials GmbH) while stirring. Thereafter, the resulting polymer systems 1.1 to C4.2 were adjusted to a solids content of 5% by weight by diluting with deionized water, and referred to subsequently as binder liquors 1.1 to C4.2.

### Production of the Bound Fiber Webs

To produce the bound fiber webs, the starting web used was a glass fiber web (length 28.5 cm, width 27 cm) with a basis weight of 56 g/m² from Whatman International Ltd.

To apply the binder liquors (impregnation), the glass fiber webs were each passed through the aforementioned 5% by weight aqueous binder liquors 1.1 to C4.2 in longitudinal direction by means of a continuous PES sieve belt with a belt speed of 200 cm per minute. By subsequent absorption of the aqueous binder liquors, the wet application rate was adjusted to 224 g/m² (corresponding to 11.2 g/m² of binder, calculated in solid form). The impregnated glass fiber webs thus obtained were dried and cured in a Mathis oven on a plastic mesh as a support at 180° C. with maximum hot air flow for 3 minutes. After cooling to room temperature, test strips with a size of 240×50 mm were cut to size in longitudinal fiber direction. The resulting test strips were subsequently stored under controlled climatic conditions of 23° C. and 50% relative air humidity for 24 hours. The glass fiber web test strips obtained according to the binder liquors 1.1 to C4.2 used are referred to hereinafter as test strips 1.1 to C4.2.

### Determination of Tear Strength

The tear strength was determined at room temperature on a Zwick-Roell Z005 tensile tester.

The test strips 1.1 to C4.2 were introduced vertically a clamp device such that the free clamped length was 200 mm. Thereafter, the clamped test strips were pulled in opposite directions at a rate of 25 mm per minute until the test strips tore. The tear strength is reported with normalization to 67 g/m² in newtons per 50 mm. The higher the force required to tear the test strips, the better the assessment of the corresponding tear strength. 5 measurements were effected in each case. The values reported in table 2 are each the mean of these measurements.

### Determination of Wet Tear Strength

To determine the wet tear strength, the test strips were stored in deionized water at 80° C. for 15 minutes and then excess water was dabbed off with a cotton fabric. The tear strength was determined on a Zwick-Roell Z005 tensile tester. The test strips 1.1 to C4.2 were introduced vertically a clamp device such that the free clamped length was 200 mm. Thereafter, the clamped test strips were pulled in opposite directions at a rate of 25 mm per minute until the test strips tore. The higher the force required to tear the test strips, the better the assessment of the corresponding tear strength. 5 separate measurements were effected in each case. The values reported in table 2 are each the mean of these measurements.

TABLE 2
Results of tear strength and wet tear strength at room temperature

| | Tear strength at | Wet tear strength at |
|---|---|---|
| | room temperature | room temperature |
| Test strip | [in N/50 mm] | [in N/50 mm] |
| 1.1 | 103 | 40 |
| 1.2 | 112 | 47 |
| 1.3 | 118 | 51 |
| 1.4 | 120 | 53 |
| 2.1 | 109 | 50 |
| 2.2 | 115 | 54 |
| 3.1 | 109 | 36 |
| 3.2 | 113 | 41 |
| 4.1 | 103 | 32 |
| 4.2 | 109 | 39 |
| C1.1 | 84 | 33 |
| C1.2 | 93 | 40 |
| C1.3 | 97 | 44 |
| C1.4 | 101 | 45 |
| C2.1 | 101 | 38 |
| C2.2 | 107 | 44 |
| C3.1 | 94 | 29 |
| C3.2 | 98 | 32 |
| C4.1 | 99 | 29 |
| C4.2 | 103 | 35 |

It is clearly evident from the results that the fiber webs produced with the inventive binder systems have improved tear strength and improved wet tear strength at room temperature.

1. A process for producing an aqueous binder system, which comprises, in a first process stage, free-radically polymerizing
≧50 and ≦100 parts by weight of at least one α, β-monoethylenically unsaturated mono- or dicarboxylic acid and/or anhydride thereof (monomer A1), and
≧0 and ≦50 parts by weight of at least one other ethylenically unsaturated compound copolymerizable with monomers A1 (monomer A2),
where the total amounts of monomers A1 and A2 add up to 100 parts by weight [total amount of monomers], in an aqueous medium in the presence of 0.1 and 150% by weight, based on the total amount of monomers, of at least one saccharide compound B, and then, in a second process stage, adding to the polymerization mixture obtained in the first process stage 0.1 and 70% by weight, based on the total amount of monomers, of at least one alkanolamine having at least two hydroxyl groups (alkanolamine C).

2. The process according to claim 1, wherein ≧85 and ≦100 parts by weight of at least one monomer A1 and ≧0 and ≦15 parts by weight of at least one monomer A2 are used.

3. The process according to either of claims 1 and 2, wherein the monomers A1 used are acrylic acid, methacrylic acid, maleic acid, maleic anhydride and/or itaconic acid, and the monomers A2 used are methyl acrylate, ethyl acrylate, n-butyl acrylate, 2-ethylhexyl acrylate, methyl methacrylate and/or styrene.

4. The process according to any of claims 1 to 3, wherein at least a portion of monomers A1 and A2 is supplied continuously to the aqueous medium under polymerization conditions.

5. The process according to any of claims 1 to 4, wherein at least a portion of the saccharide compound B is initially charged in the aqueous medium.

6. The process according to any of claims 1 to 5, wherein the entirety of the saccharide compound B is initially charged in the aqueous medium.

7. The process according to any of claims 1 to 6, wherein the saccharide compound B used is starch, cellulose, guaran, xanthan, alginate, pectin, chitosan, gum arabic, carrageenan, agar, gellan and derivatives and/or substitution products thereof.

8. The process according to any of claims 1 to 7, wherein the saccharide compound B used is starch and derivatives and/or substitution products thereof.

9. The process according to any of claims 1 to 8, wherein the saccharide compound B has a weight-average molecular weight of >3000 and ≦10 000 g/mol.

10. The process according to any of claims 1 to 9, wherein the total amount of saccharide compound B is >30 and ≦100% by weight, based on the total amount of monomers.

11. The process according to any of claims 1 to 10, wherein the alkanolamine C used is diethanolamine, triethanolamine, diisopropanolamine, triisopropanolamine, methyldiethanolamine, butyldiethanolamine and/or methyldiisopropanolamine.

12. The process according to any of claims 1 to 11, wherein the total amount of alkanolamine C is ≧10 and ≦50% by weight, based on the total amount of monomers.

13. An aqueous binder system obtainable by a process according to any of claims 1 to 12.

14. The use of an aqueous binder system according to claim 13 for production of adhesives, sealants, synthetic renders, paper coating slips, shaped articles, paints and impact modifiers, and for modification of mineral binders and polymers.

15. A process for producing a shaped article from a granular and/or fibrous substrate, which comprises applying an aqueous binder system according to claim 13 to the granular and/or fibrous substrate, optionally shaping the granular and/or fibrous substrate treated with the aqueous binder system and then subjecting the treated granular and/or fibrous substrate to a thermal treatment step at a temperature of ≧110° C.

16. The process according to claim 15, wherein ≧0.1 g and ≦100 g of aqueous binder system (calculated as the sum of the total amounts of monomers A1, monomers A2, saccharide compounds B and alkanolamines C based on solids) are used per 100 g of granular and/or fibrous substrate.

17. The process according to claim 15 or 16, wherein the thermal treatment step is preceded by a drying step.

18. A shaped article obtainable by a process according to any of claims 15 to 17.
